(19) United States
(12) Patent Application Publication
(10) Pub. No.: US 2022/0179589 A1
(43) Pub. Date: Jun. 9, 2022

(54) SYSTEM, SUBSTRATE PROCESSING APPARATUS, METHOD OF MANUFACTURING SEMICONDUCTOR DEVICE, AND RECORDING MEDIUM

(71) Applicant: KOKUSAI ELECTRIC CORPORATION, Tokyo (JP)

(72) Inventor: Shinichiro MORI, Toyama-shi (JP)

(73) Assignee: KOKUSAI ELECTRIC CORPORATION, Tokyo (JP)

(21) Appl. No.: 17/679,781

(22) Filed: Feb. 24, 2022

Related U.S. Application Data
(63) Continuation of application No. PCT/JP2019/036568, filed on Sep. 18, 2019.

(51) Int. Cl. G06F 3/06

(52) U.S. Cl. CPC G06F 3/0659; G06F 3/0629; G06F 3/0673; G06F 3/0604; G06F 3/0652

(57) ABSTRACT

There is provided a technique that includes at least one sub-controller configured to be capable of controlling at least one module; and a main controller including a memory configured to be capable of including a first storage configured to be capable of storing a system file currently set in the module and a second storage configured to be capable of storing a history of uploading or downloading of the system file for the module as history information, wherein the main controller is configured to, when transmitting and receiving the system file to and from the sub-controller, store the transmitted or received system file in the first storage and store the history information of the system file in the second storage, according to a comparison result between the transmitted or received system file and the system file stored in the first storage.

### CROSS-REFERENCE TO RELATED APPLICATION(S)

This application is a Bypass Continuation Application of PCT International Application No. PCT/JP2019/036568, filed on Sep. 18, 2019, the entire content of which is incorporated herein by reference.

### TECHNICAL FIELD

The present disclosure relates to a system, a substrate processing apparatus, a method of manufacturing a semiconductor device, and a recording medium.

### BACKGROUND

A semiconductor manufacturing apparatus, which is a substrate processing apparatus for performing a predetermined process on a substrate, performs a predetermined process on a substrate by controlling various modules such as a mass flow controller (MFC), which is a flow rate controller, a sequencer, and the like. When a process is performed by using a semiconductor manufacturing apparatus, the process result may be changed significantly depending on the combination of setting data of various modules.

In a related art, there is disclosed a technique that includes a process module for processing a substrate, a process controller for controlling a temperature, a pressure and a gas flow rate in the process module according to a first parameter file, a transfer controller for controlling a mechanism for transfer of a substrate according to a second parameter file, and an operation controller for providing a control instruction to the process controller and the transfer controller to execute the processing of the substrate. An operation unit checks the consistency among the first parameter file, the second parameter file, and a third parameter file held by the operation controller. If the files are consistent, a control instruction is provided.

In this specification, the setting data and the table file used for film formation are referred to as system files. In addition, the semiconductor manufacturing apparatus and the like contain a function called backup for storing a combination of system files. Further, the semiconductor manufacturing apparatus and the like contain a function called restoration for restoring (downloading) the combination. When upgrading the software used in the semiconductor manufacturing apparatus, the setting data of various modules may be erased. Therefore, backup is performed before the software upgrade, and restoration may be performed after the software upgrade. At this time, it may not be possible to restore the system files to their original states due to forgetting the backup and performing the upgrade.

### SUMMARY

Some embodiments of the present disclosure provide a technique capable of upgrading the software installed in a semiconductor manufacturing apparatus without affecting the data of system files.

According to one or more embodiments of the present disclosure, there is provided a technique that includes at least one sub-controller configured to be capable of controlling at least one module; and a main controller including a memory configured to be capable of including a first storage configured to be capable of storing a system file currently set in the module and a second storage configured to be capable of storing a history of uploading or downloading of the system file for the module as history information, wherein the main controller is configured to, when transmitting and receiving the system file to and from the sub-controller, store the transmitted or received system file in the first storage and store the history information of the system file in the second storage, according to a comparison result between the transmitted or received system file and the system file stored in the first storage.

### BRIEF DESCRIPTION OF DRAWINGS

The accompanying drawings, which are incorporated in and constitute a part of the specification, illustrate embodiments of the present disclosure.

FIG. 1 is a perspective view showing a substrate processing apparatus preferably used in one or more embodiments of the present disclosure.

FIG. 2 is a side sectional view showing the substrate processing apparatus preferably used in one or more embodiments of the present disclosure.

FIG. 3 is a schematic configuration diagram of a control system of the substrate processing apparatus preferably used in one or more embodiments of the present disclosure.

FIG. 4 is a diagram showing a hardware configuration of a main controller of the substrate processing apparatus preferably used in one or more embodiments of the present disclosure.

FIG. 5 is a block diagram for explaining a memory of the main controller of the substrate processing apparatus preferably used in one or more embodiments of the present disclosure.

FIG. 6 is a diagram for explaining history information of system files stored in the memory of the main controller of the substrate processing apparatus preferably used in one or more embodiments of the present disclosure.

FIG. 7 is a flowchart showing an operation of the main controller of the substrate processing apparatus preferably used in one or more embodiments of the present disclosure.

FIG. 8 is a diagram for explaining the operation of the main controller of the substrate processing apparatus preferably used in one or more embodiments of the present disclosure.

FIG. 9 is a diagram for explaining the operation of the main controller of the substrate processing apparatus preferably used in one or more embodiments of the present disclosure.

FIG. 10 is a flowchart showing the operation of the main controller of the substrate processing apparatus preferably used in one or more embodiments of the present disclosure.

FIG. 11 is a diagram for explaining the operation of the main controller of the substrate processing apparatus preferably used in one or more embodiments of the present disclosure.

FIG. 12 is a diagram for explaining the operation of the main controller of the substrate processing apparatus preferably used in one or more embodiments of the present disclosure.

FIG. 13 is a flowchart showing the operation of the main controller of the substrate processing apparatus preferably used in one or more embodiments of the present disclosure.

FIG. 14 is a diagram for explaining the operation of the main controller of the substrate processing apparatus preferably used in one or more embodiments of the present disclosure.

FIG. 15 is a flowchart showing the operation of the main controller of the substrate processing apparatus preferably used in one or more embodiments of the present disclosure.

FIG. 16 is a diagram for explaining the operation of the main controller of the substrate processing apparatus preferably used in one or more embodiments of the present disclosure.

FIG. 17 is a diagram for explaining the operation of the main controller of the substrate processing apparatus preferably used in one or more embodiments of the present disclosure.

FIG. 18 is a diagram for explaining the operation of the main controller of the substrate processing apparatus preferably used in one or more embodiments of the present disclosure.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to obscure aspects of the various embodiments.

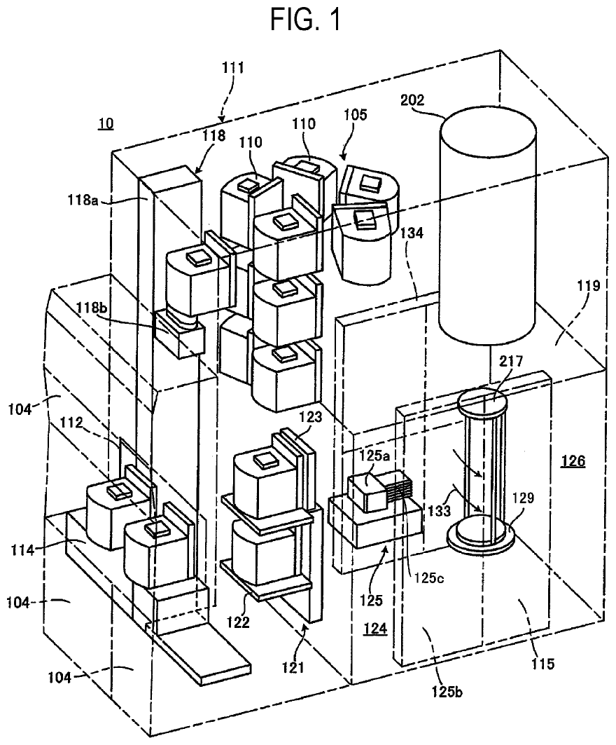

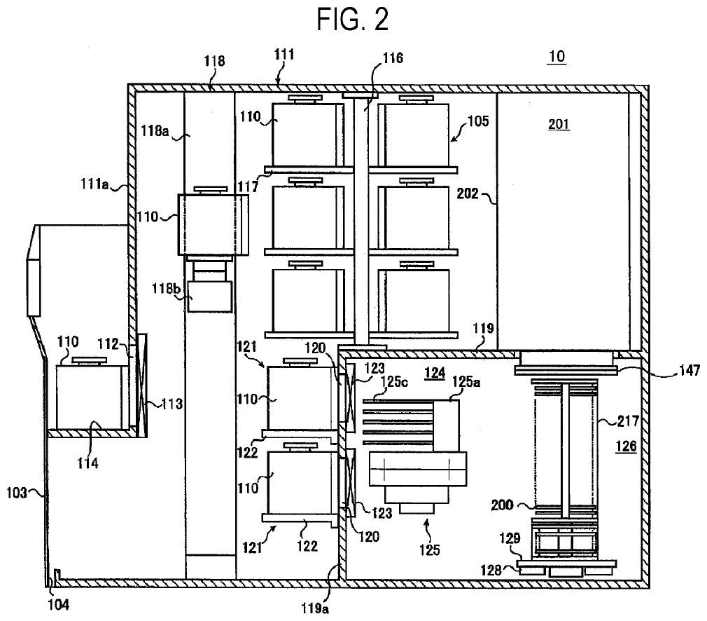

Hereinafter, one or more embodiments of the present disclosure will be described with reference to the drawings. First, the substrate processing apparatus 10 in which the present disclosure is performed will be described with reference to FIGS. 1 and 2.

The substrate processing apparatus 10 includes a housing 111. A front maintenance port 103 as an opening provided so as to be maintainable is opened at a lower portion of a front wall 111a of the housing 111. The front maintenance port 103 is opened and closed by a maintenance door 104.

A pod-loading/unloading port 112 is provided on the front wall 111a of the housing 111 so as to bring the inside and outside of the housing 111 into communication with each other. The pod-loading/unloading port 112 is opened and closed by a front shutter (loading/unloading-port-opening/closing mechanism) 113. A load port (substrate transfer container delivery stand) 114 is installed on the front side of the pod-loading/unloading port 112. The load port 114 is configured to align the mounted pod 110.

The pod 110 is a closed-type substrate transfer container and is configured to be loaded onto the load port 114 and unloaded from the load port 114 by an in-process transfer device (not shown).

A rotary pod shelf (substrate transfer container storage shelf) 105 is installed at the substantially central upper portion of the housing 111 in the front-rear direction. The rotary pod shelf 105 is configured to store a plurality of pods 110.

The rotary pod shelf 105 includes a column 116 which is vertically installed and intermittently rotated, and a multi-stage shelf plates (substrate transfer container mounting shelves) 117 which are radially supported by the column 116 at the respective positions of the upper, middle, and lower stages. The shelf plates 117 are configured to store a plurality of pods 110 in a state in which the pods are placed on the shelf plates 117.

A pod opener (substrate transfer container lid opening/closing mechanism) 121 is installed below the rotary pod shelf 105. The pod opener 121 is configured to mount the pod 110 thereon and to open/close the lid of the pod 110.

A pod transfer mechanism (container transfer mechanism) 118 is installed among the load port 114, the rotary pod shelf 105, and the pod opener 121. The pod transfer mechanism 118 that holds the pod 110 can move up and down and can move forward and backward in the horizontal direction. The pod transfer mechanism 118 is configured to transfer the pod 110 among the load port 114, the rotary pod shelf 105, and the pod opener 121.

A sub-housing 119 is installed at the substantially central lower portion of the housing 111 in the front-rear direction to extend to the rear end of the housing 111. On the front wall 119a of the sub-housing 119, a pair of wafer-loading/unloading ports (substrate-loading/unloading ports) 120 for loading/unloading the wafer (substrate) 200 into the sub-housing 119 are arranged in two stages in a vertical direction. Pod openers 121 are provided for the upper and lower wafer-loading/unloading ports 120, respectively.

The pod opener 121 includes a mounting table 122 on which the pod 110 is mounted, and an opening/closing mechanism 123 for opening and closing the lid of the pod 110. Each of the pod openers 121 is configured to open and close the wafer entrance of the pod 110 by opening and closing the lid of the pod 110 mounted on the mounting table 122 by the opening/closing mechanism 123.

The sub-housing 119 constitutes a transfer chamber 124 kept airtight from a space (pod transfer space) in which the pod transfer mechanism 118 and the rotary pod shelf 105 are arranged. A wafer transfer mechanism (substrate transfer mechanism) 125 is installed in the front region of the transfer chamber 124. The wafer transfer mechanism 125 is provided with a desired number of (five, in the drawings) wafer mounting plates 125c on which the wafers 200 are mounted. The wafer mounting plates 125c can move linearly in the horizontal direction, rotate in the horizontal direction, and move up and down. The wafer transfer mechanism 125 is configured to charge and discharge the wafers 200 with respect to the boat (substrate holder) 217.

A standby part 126 for accommodating the boat 217 and keeping the boat 217 in a standby state is installed in the rear region of the transfer chamber 124, and a vertical process furnace 202 is installed above the standby part 126. The process furnace 202 defines a process chamber 201 therein. The lower end portion of the process chamber 201 is a furnace port. The furnace port is opened and closed by a furnace port shutter (furnace port opening/closing mechanism) 147.

A boat elevator (substrate holder elevating mechanism) 115 for raising and lowering the boat 217 is installed between the right end of the housing 111 and the right end of the standby part 126 of the sub-housing 119. A seal cap 129 as a lid is horizontally attached to the arm 128 connected to the elevating stand of the boat elevator 115. The seal cap 129 is configured to vertically support the boat 217 and hermetically seal the furnace port shutter 147 in a state in which the boat 217 is loaded into the process chamber 201.

The boat 217 is configured to align a plurality of (e.g., about 50 to 125) wafers 200 at the center thereof and hold the wafers 200 in multiple stages in a horizontal posture.

A clean unit 134 is arranged at a position facing the boat elevator 115. The clean unit 134 includes a supply fan and a dustproof filter so as to supply a clean air 133 which is a clean atmosphere or an inert gas. A notch alignment device (not shown) as a substrate alignment device for aligning the positions of the wafer 200 in the circumferential direction is installed between the wafer transfer mechanism 125 and the clean unit 134.

The clean air 133 blown out from the clean unit 134 is allowed to flow through the notch alignment device (not shown), the wafer transfer mechanism 125, and the boat 217. Then, the clean air 133 is sucked by a duct (not shown) and exhausted to the outside of the housing 111. Alternatively, the clean air 133 is blown into the transfer chamber 124 by the clean unit 134.

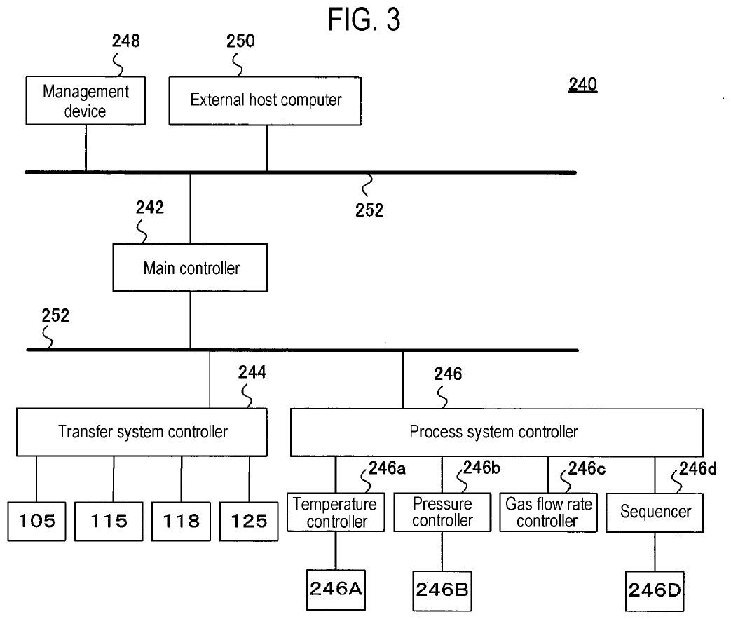

Next, the configuration of the control system 240 centered on the main controller 242 will be described with reference to FIG. 3. As shown in FIG. 3, the control system 240 includes a main controller 242, a transfer system controller 244 as a transfer control part, a process system controller 246 as a process control part, a management device 248, and an external host computer 250, which are connected by a LAN (Local Area Network).

The transfer system controller 244 is mainly connected to the transfer module such as the rotary pod shelf 105, the boat elevator 115, the pod transfer mechanism (substrate container transfer mechanism) 118, and the wafer transfer mechanism (substrate transfer mechanism) 125. The transfer system controller 244 is configured to control the transfer operations of the transfer module such as the rotary pod shelf 105, the boat elevator 115, the pod transfer mechanism 118, the wafer transfer mechanism 125, and the like.

The process system controller 246 includes a temperature controller 246a, a pressure controller 246b, a gas flow rate controller 246c, and a sequencer 246d.

A heating mechanism 246A mainly including a heater, a temperature sensor, and the like is connected to the temperature controller 246a. The temperature controller 246a is configured to adjust the temperature in the process furnace 202 by controlling the temperature of the heater of the process furnace 202. The temperature controller 246a is configured to control the switching (on/off) of a thyristor and control the electric power supplied to a heater wire.

A gas exhaust mechanism 246B mainly including a pressure sensor, an APC valve as a pressure valve, and a vacuum pump is connected to the pressure controller 246b. The pressure controller 246b is configured to control the opening degree of the APC valve and the switching (on/off) of the vacuum pump based on the pressure value detected by the pressure sensor so that the pressure in the process chamber 201 becomes a desired pressure at a desired timing.

The gas flow rate controller 246c includes a gas supply mechanism such as an MFC or the like. A valve 246D is connected to the sequencer 246d. The supply and stop of the gas from the processing gas supply pipe and the purge gas supply pipe is controlled by opening and closing the valve 246D. Further, the process system controller 246 is configured to control the gas flow rate controller 246c (MFC) and the sequencer 246d (the valve 246D) so that the flow rate of the gas supplied into the process chamber 201 becomes a desired flow rate at a desired timing.

That is, the process system controller 246 (the temperature controller 246a, the pressure controller 246b, the gas flow rate controller 246c and the sequencer 246d) is mainly connected to the process module such as the heating mechanism 246A, the gas exhaust mechanism 246B, the gas supply mechanism (MFC), the valve 246D, and the like. The process system controller 246 is configured to control the substrate processing operation of the process module such as the heating mechanism 246A, the gas exhaust mechanism 246B, the gas supply mechanism (MFC), the valve 246D, and the like.

Each of the transfer system controller 244 and the process system controller 246 (the temperature controller 246a, the pressure controller 246b, the gas flow rate controller 246c, and the sequencer 246d) constitutes a sub-controller. Further, since the main controller 242 is electrically connected to the transfer system controller 244 and the process system controller 246 by a LAN 252, the main controller 242 can transmit and receive the system files for the transfer module and the process module or can download and upload the system files.

The main controller 242, the transfer system controller 244, and the process system controller 246 according to the embodiments of the present disclosure can be realized by using a general computer system without limiting to a dedicated system. For example, each of the controllers for executing a predetermined process can be configured by installing, on a general-purpose computer, a program for executing the above-described process from a recording medium (a non-transitory computer-readable recording medium) (a flexible disk, a CD-ROM, a USB, etc.) 308 that stores the program.

The means for supplying the program is arbitrary. The program may be supplied via, for example, a communication line, a communication network, a communication system, or the like, in addition to the predetermined recording medium mentioned above. In this case, for example, the program may be posted on a bulletin board of a communication network, and the program may be superposed on a carrier wave and provided via a network. Then, a predetermined process can be executed by starting the program provided in this way and executing it in the same manner as other application programs under the control of an operating system.

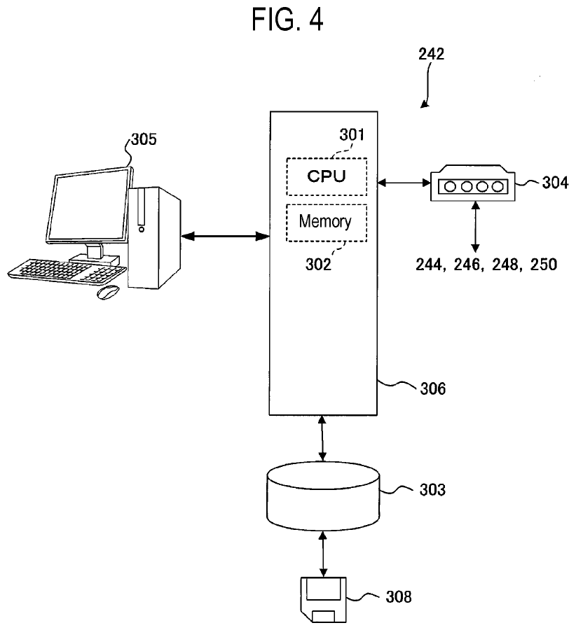

Next, the configuration of the main controller 242 will be described with reference to FIG. 4.

The main controller 242 is configured as a computer that includes a CPU (central processing unit) 301 as a processing part, a memory (a RAM, a ROM, etc.) 302 as a temporary memory, a memory 303 such as a hard disk (HDD) or the like, a transmission/reception module 304 as a communication part, a display device 305 as a display unit, and a clock function (not shown). Although details will be described later, the memory 303 stores system files for the respective modules such as each recipe file such as a recipe in which processing conditions and processing procedures are defined, a control program file for executing each recipe file, a parameter file for setting processing conditions and processing procedures, and the like.

The display device 305 is configured to display an operation screen for operating the substrate processing apparatus 10. The operation screen of the display device 305 is, for example, a liquid crystal display panel. The operation screen of the display device 305 includes a screen for checking the status of each module such as a transfer module, a process module, or the like. The display device 305 displays the information generated in the substrate processing apparatus 10 via the operation screen on the operation screen. Further, the display device 305 outputs the information displayed on the operation screen to a device such as a USB memory or the like inserted into the main controller 242. The display device 305 receives the input data (input instruction) of an operator from the operation screen and transmits the input data to the CPU 301. Further, the display device 305 receives an instruction (control instruction) for downloading an arbitrary system file among the system files stored in the memory 303 or the like described later and transmits the instruction to the CPU 301.

A switching hub or the like is connected to the transmission/reception module 304 of the main controller 242 and is configured so that the CPU 301 transmits and receives data such as the system files or the like to and from an external computer such as the transfer system controller 244 or the process system controller 246 as a sub-controller via a network. Further, the main controller 242 may be configured to include a main control part 306 including at least a CPU 301 and a memory 302, a transmission/reception module 304 that transmits and receives data to and from an external computer via a network, a memory 303 such as a hard disk drive or the like, and a user interface (UI) part including a display part such as a liquid crystal display or the like and a pointing device such as a keyboard, a mouse or the like. Further, the main control part 306 may be configured to further include a transmission/reception module 304. In the present embodiments, when downloading each recipe file such as a recipe, in which processing conditions and processing procedures are defined, from the main controller 242 to each sub-controller, the system files for the respective modules, such as a parameter file for setting processing conditions and processing procedures, and the like may also be downloaded additionally (as a set) to the sub-controller.

Further, the main controller 242 transmits apparatus data such as the state of the substrate processing apparatus 10 or the like to the external host computer 250 and the management device 248 via the network.

Next, a substrate-processing process including a predetermined processing process performed by using the substrate processing apparatus 10 will be described. In the present embodiments, the predetermined processing process will be described by taking, as an example, a case where a substrate-processing process, which is a process of manufacturing a semiconductor device, is performed.

In performing the substrate-processing process, the substrate-processing recipe (process recipe) corresponding to the substrate processing to be performed is expanded (downloaded) to, for example, a memory such as a RAM or the like in the process system controller 246 or the transfer system controller 244. Then, an operation instruction may be provided from the main controller 242 to the process system controller 246 and the transfer system controller 244.

### (Transfer Step)

From the main controller 242, a drive instruction for the transfer module is provided to the transfer system controller 244. Then, when the pod 110 is supplied to the load port 114 while following the instructions from the transfer system controller 244, the pod-loading/unloading port 112 is opened by the front shutter 113. The pod 110 on the load port 114 is loaded into the housing 111 by the pod transfer mechanism 118 via the pod-loading/unloading port 112 and is placed on the designated shelf plate 117 of the rotary pod shelf 105. The pod 110 is temporarily stored on the rotary pod shelf 105. Thereafter, the pod 110 is transferred from the shelf plate 117 to one of the pod openers 121 by the pod transfer mechanism 118 and transferred to the mounting table 122 or is directly transferred from load port 114 to the mounting table 122.

At this time, the wafer-loading/unloading port 120 is closed by the opening/closing mechanism 123. The transfer chamber 124 is filled with the clean air 133 flowing therethrough. For example, the transfer chamber 124 is filled with a nitrogen gas as the clean air 133, so that the oxygen concentration is set to 20 ppm or less, which is much lower than the oxygen concentration inside the housing 111 (atmosphere).

The opening side end surface of the pod 110 mounted on the mounting table 122 is pressed against the opening edge of the wafer-loading/unloading port 120 in the front wall 119a of the sub- housing 119, and the lid of the pod 110 is removed by the opening/closing mechanism 123 to open the wafer entrance thereof.

When the pod 110 is opened by the pod opener 121, the wafer 200 is taken out from the pod 110 by the wafer transfer mechanism 125, and the transfer process of the wafer 200 from the pod 110 on the mounting table 122 to the boat 217 is started. This transfer process is performed until the charging of the scheduled wafers 200 into the boat 217 is completed.

### (Loading Step)

When a specified number of wafers 200 are charged to the boat 217, the boat 217 is raised by the boat elevator 115 operating according to the instruction from the transfer system controller 244 and is loaded into the process chamber 201 formed in the process furnace 202 (Boat Loading). When the boat 217 is completely loaded, the seal cap 129 of the boat elevator 115 airtightly closes the lower end of the manifold of the process furnace 202.

### (Film-Forming Step)

Thereafter, the inside of the process chamber 201 is evacuated by the vacuum exhaust device so as to contain a predetermined film-forming pressure (vacuum degree) while following the instruction from the pressure controller 246b. At this time, the pressure in the process chamber 201 is measured by the pressure sensor, and the pressure adjustment device is feedback-controlled based on the measured pressure information. Further, the inside of the process chamber 201 is heated by the heater so as to reach a predetermined temperature while following the instruction from the temperature controller 246a. At this time, the state of supplying electric power to the heater is feedback-controlled based on the temperature information detected by the temperature sensor as a temperature detector so that the temperature in the process chamber 201 becomes a predetermined temperature (film-forming temperature). Subsequently, the rotation of the boat 217 and the wafers 200 by the rotation mechanism is started while following the instruction from the transfer system controller 244. Then, predetermined gases (processing gases) are supplied to the wafers 200 held by the boat 217 while maintaining the predetermined pressure and the predetermined temperature, whereby a predetermined process (e.g., film-forming process) is performed on the wafers 200.

### (Unloading Step)

When the film-forming step for the wafers 200 mounted on the boat 217 is completed, the rotation of the boat 217 and the wafers 200 by the rotation mechanism is then stopped while following the instruction from the transfer system controller 244. The seal cap 129 is lowered by the boat elevator 115 to open the lower end of the manifold. The boat 217 holding the processed wafers 200 is unloaded out of the process furnace 202 (boat unloading).

### (Recovery Step)

Then, the boat 217 holding the processed wafers 200 is cooled extremely effectively by the clean air 133 blown from the clean unit 134. Then, for example, when cooled to 150 degrees C. or lower, the processed wafers 200 are discharged from the boat 217 (wafer discharging) and transferred to the pod 110. Thereafter, new unprocessed wafers 200 are charged to the boat 217.

By performing each of the above-described steps one or more times via the execution of the process recipe, the substrate processing apparatus 10 according to the present embodiments can form, for example, a silicon film on the wafer 200 with high throughput.

The memory 303 of the main controller 242 stores system files such as setting data and recipes for executing the operations of various modules such as the transfer module and the process module. Combinations of the system files for various modules such as heater temperature and the gas flow rate at the time of executing film formation are preferably stored because the film formation result varies depending on the combinations. According to the present embodiments, in order for the main controller 242 to restore the combination of system files at an arbitrary time in the substrate-processing process, when uploading or downloading the system files in various modules, the uploaded system file or the downloaded system file is stored in the memory 303 of the main controller 242. Hereinafter, when the transport module and the process module are generically referred to in the subject specification, they may be simply referred to as modules.

Next, the memory 303 of the main controller 242 will be described in detail. Hereinafter, description will be made on a case where a module A and a module B controlled by the sub-controllers such as the transfer system controller 244 and the process system controller 246 are connected to the main controller 242.

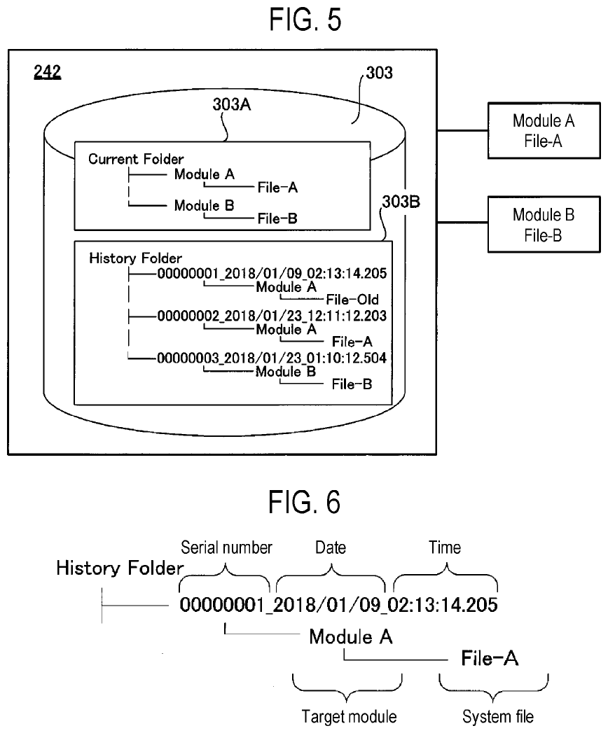

As shown in FIG. 5, the memory 303 includes a current folder 303A as a first storage and a history folder 303B as a second storage. In FIG. 5, the sub-controllers such as the transfer system controller 244 and the process system controller 246 are omitted.

The current folder 303A stores combinations of system files currently set in a plurality of modules. Specifically, the current folder 303A stores subfolders (with module names) indicating a plurality of currently connected modules, and each subfolder stores the system file currently set for each module. That is, as shown in FIG. 5, the system file (File-A) currently set in the module A is stored in the subfolder for the module A of the current folder 303A, and the system file (File-B) currently set in the module B is stored in the subfolder for the module B of the current folder 303A.

The history folder 303B stores information on the system file uploaded or downloaded for each module in a chronological order. Specifically, when uploading or downloading is successful for the module A and the module B, the history folder 303B stores a subfolder whose folder name is the date on which the uploading or downloading was performed. In this subfolder, information about the uploaded or downloaded system file and information about the module for which the uploading or downloading is performed are stored as history information. That is, the history information, which shows a change history of the system files for the module A and the module B, is stored in the history folder 303B.

FIG. 6 is a diagram showing an example of the subfolder stored in the history folder 303B. The history folder 303B stores a subfolder whose folder name includes the serial number incremented by 1 in an order stored in the history folder 303B and the date and time of when the system file was uploaded or downloaded. This subfolder stores information about the uploaded or downloaded system file and information about the module for which the uploading or downloading was performed. The folder name is used as history information.

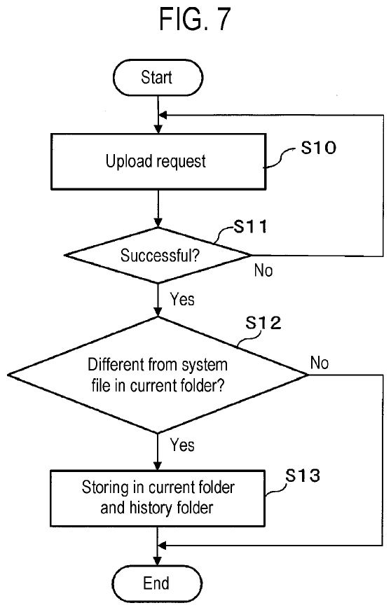

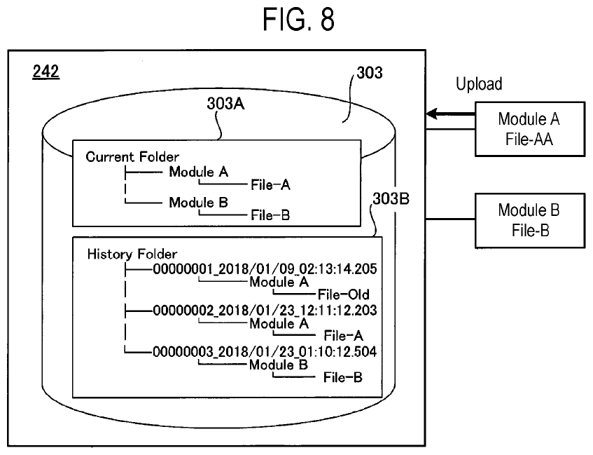

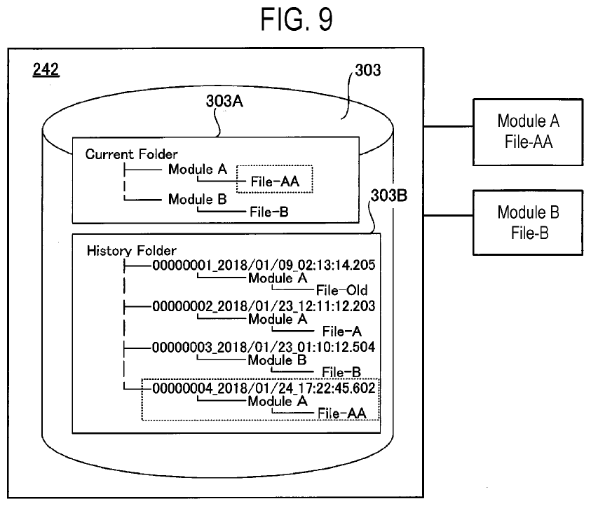

Next, the operation of storing the system file of the main controller 242 in the memory 303 when uploading the system file indicating a target module will be described with reference to FIGS. 7 to 9. In FIGS. 8 and 9, the sub-controllers such as the transfer system controller 244 and the process system controller 246 are omitted.

First, in step S10, when connecting to various modules, the main controller 242 makes a request to upload system file for the connected modules. That is, the main controller 242 makes an upload request when communication with various modules is started or when a new module is connected. As a result, the system files for the connected modules can be acquired without omission.

In step S11, the main controller 242 determines whether the system file uploading is successful. If the uploading fails in step S11, the process returns to step S10.

Next, when the system file for each module is successfully uploaded in step S12, the main controller 242 compares the uploaded system file with the system file of the target module stored in the current folder 303A.

Then, according to the comparison result between the system file uploaded as described above and the system file of the target module stored in the current folder 303A, in step S13, the system file uploaded for each module is stored (overwritten) in the subfolder for the target module of the current folder 303A, a subfolder that uses the date of uploading to the history folder 303B as the folder name thereof is created, and the system file is stored in this subfolder. That is, the history information of the system file is stored in the history folder 303B.

Specifically, if the uploaded system file (File-AA) for the module A is different from the system file (File-A) stored in the subfolder for the module A of the current folder 303A as shown in FIG. 8, the uploaded system file (File-AA) for the module A is stored and overwritten in the subfolder for the module A of the current folder 303A as shown in FIG. 9, a subfolder whose folder name includes the serial number incremented by 1 from the largest serial number stored in the history folder 303B and the date and time of when the system file was uploaded is created in the history folder 303B, and information about the module A for which the uploading is performed and the uploaded system file (File-AA) are stored in this subfolder.

Further, if the uploaded system file is the same as the system file stored in the subfolder for the target module of the current folder 303A (if there is no difference) in step S12, the process is terminated without doing anything.

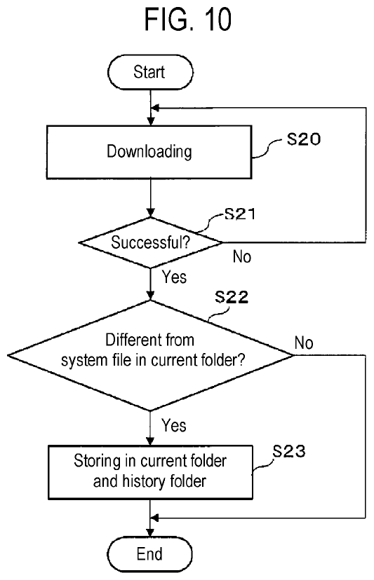

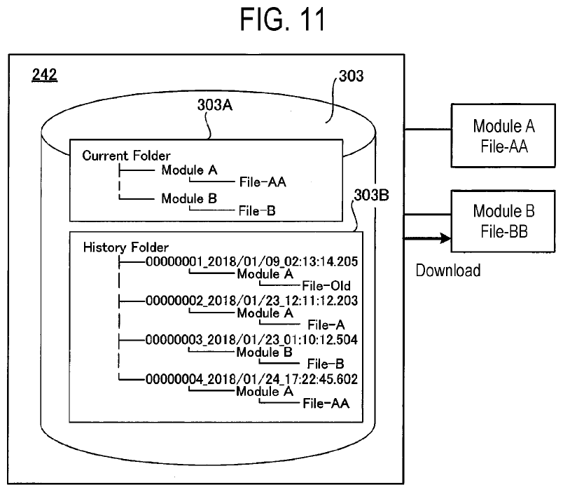

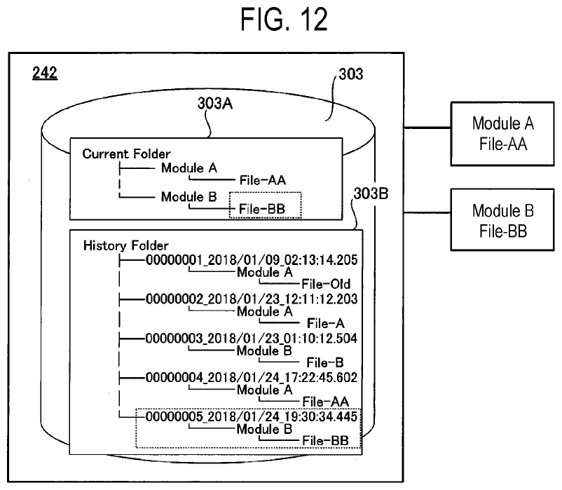

Next, the operation of storing the system file of the main controller 242 in the memory 303 when the system file of the target module is downloaded will be described with reference to FIGS. 10 to 12. In FIGS. 11 and 12, the sub-controllers such as the transfer system controller 244 and the process system controller 246 are omitted.

First, in step S20, the main controller 242 receives a download request for a system file for each module and downloads the system file. The download request will be described in detail later.

In step S21, the main controller 242 determines whether the system file for each module is successfully downloaded. If the downloading fails in step S21, the process returns to step S20.

Next, when the system file for each module is successfully downloaded in step S22, the main controller 242 compares the downloaded system file for each module with the system file of the target module stored in the current folder 303A.

Then, according to the comparison result between the downloaded system file for each module and the system file of the target module stored in the current folder 303A, in step S23, the system file downloaded for each module is stored (overwritten) in the subfolder for the target module of the current folder 303A, a subfolder that uses the date of downloading to the history folder 303B as the folder name thereof is created, and the system file is stored in this subfolder. That is, the history information of the system file is stored in the history folder 303B.

Specifically, when the main controller 242 downloads a system file (File-BB) for the module B, if the downloaded system file (File-BB) for the module B is different from the system file (File-B) stored in the subfolder for the module B of the current folder 303A as shown in FIG. 11, the downloaded system file (File-BB) for the module B is stored and overwritten in the subfolder for the module B of the current folder 303A as shown in FIG. 12, a subfolder whose folder name includes the serial number incremented by 1 from the largest serial number stored in the history folder 303B and the date and time of when the system file for the module B was downloaded is created in the history folder 303B, and information about the module B for which the downloading is performed and the downloaded system file (File-BB) are stored in this subfolder.

Further, if the downloaded system file for each module is the same as the system file stored in the subfolder for the target module of the current folder 303A (if there is no difference) in step S22, the process is terminated without doing anything.

That is, the current folder 303A is configured to store the same system file as the system file uploaded or downloaded from or to each module. Further, the main controller 242 is configured to store the system file uploaded or downloaded for each module in the subfolder of the history folder 303B whose folder name includes the serial number incremented by 1 in the order stored in the history folder 303B and the date and time of when the system file was uploaded or downloaded.

That is, the main controller 242 is configured to store the system file uploaded or downloaded for each module in the history folder 303B in a chronological order and, at the same time, store (overwrite) the system file uploaded or downloaded for each module in the subfolder for each module of the current folder 303A. As a result, the combinations of system files can be automatically stored, and the system files can be restored even if the backup is forgotten.

That is, when the system file for each module is uploaded and the uploaded system file is different from the system file stored in the subfolder for the target module of the current folder 303A, or when the system file for each module is downloaded and the downloaded system file is different from the system file stored in the subfolder for the target module of the current folder 303A, the main controller 242 is configured to overwrite and store the uploaded or downloaded system file in the subfolder for the target module of the current folder 303A and store the history information of the above-mentioned system file for the target module in the history folder 303B.

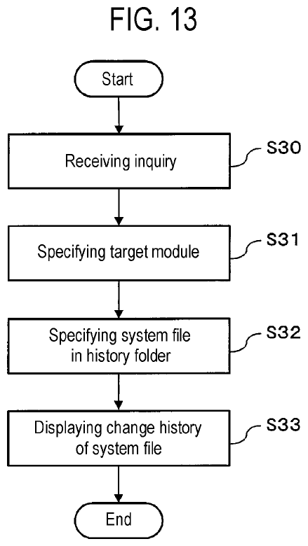

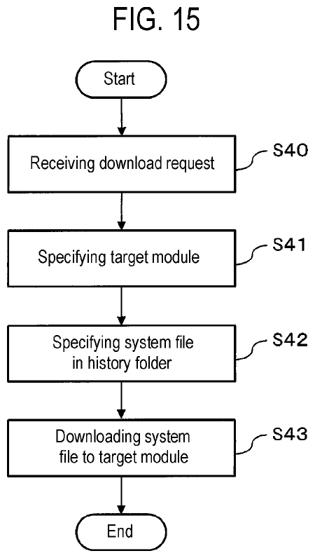

Next, the operation of restoring a system file group at a specified date and time will be specifically described with reference to FIGS. 13 to 15. For example, description will be made on a case where a system file group is restored at 10:00 on Jan. 24, 2018. The current system file setting for the module A is assumed to be File-AA, and the current system file setting for the module B is assumed to be File-BB.

First, in step S30, the main controller 242 receives an inquiry of a system file group at the date and time specified by the input data of an operator from the operation screen of the display device 305. Specifically, the main controller 242 receives a search request for a system file group at 10:00 on Jan. 24, 2018.

Next, in step S31, the main controller 242 specifies a target module. Specifically, the main controller 242 searches the subfolder of the history folder 303B for the system file changed on or after 10:00 on Jan. 24, 2018. Then, the main controller 242 specifies the module A whose system file is changed to File-AA on or after 10:00 on Jan. 24, 2018, and the module B whose system file is changed to File-BB on or after 10:00 on Jan. 24, 2018.

Next, in step S32, the main controller 242 specifies the system file stored in the history folder 303B for the specified target module. Specifically, the main controller 242 search for the system file in the newest date folder for the module A before 10:00 on Jan. 24, 2018, and the system file in the newest date folder for the module B before 10:00 on Jan. 24, 2018.

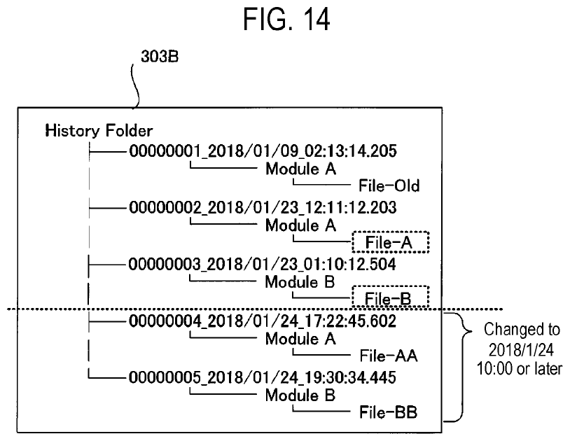

As shown in FIG. 14, the system file (File-A) in the latest subfolder for the module A at 12:11:12 203 milliseconds of 2018 Jan. 23 before the specified date and time (10:00 of 2018 Jan. 24) is specified. Similarly, the system file (File-B) in the latest subfolder for the module B at 01:10:12 504 milliseconds of 2018 Jan. 23 before the specified date and time (10:00 of 2018 Jan. 24) is specified.

Next, in step S33, the main controller 242 displays the change history of the specified system file. Specifically, the main controller 242 displays the system file (File-A) for the module A and the system file (File-B) for the module B at 10:00 of 2018 Jan. 24 in the substrate processing apparatus 10.

Then, in step S40, the main controller 242 receives a download request for the system file specified by the input data of an operator from the operation screen of the display device 305. Specifically, the main controller 242 receives a download request for the system file group at 10:00 on 2018 Jan. 24 displayed in step S33.

Next, in step S41, the main controller 242 specifies a module for which a system file group is to be downloaded. Specifically, the module corresponding to the system file specified in step S32 is specified as the module for which a system file group is to be downloaded.

Next, in step S42, the system file specified in step S32 is specified. Specifically, the system file (File-A) for the module A and the system file (File-B) for the module B specified in step S32 are specified.

Next, in step S43, the specified system file is downloaded to the target module. Specifically, the system file (File-A) and the system file (File-B) at 10:00 on 2018 Jan. 24 in the substrate processing apparatus 10 are downloaded to the module A and the module B, respectively. This makes it possible to restore the system file group as of 10:00 on Jan. 24, 2018.

Then, the operations of steps S20 to S23 in FIG. 10 described above are performed.

That is, the system file group (combinations of system files) for the module A and the module B at the specified date and time can be specified and restored.

A record is added to the history folder 303B each time when the system file is changed in each module. However, since the capacity of the memory 303 is limited, it may be possible to delete the system files in the order of the old date folder to satisfy the capacity limit of the memory 303. However, if the date folders are carelessly deleted in the order of old history, it may be impossible to restore the date folders correctly.

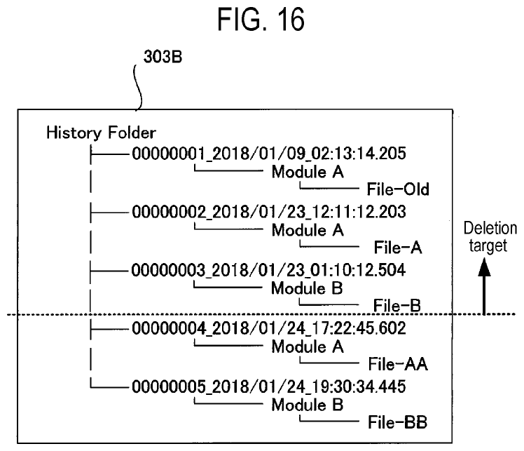

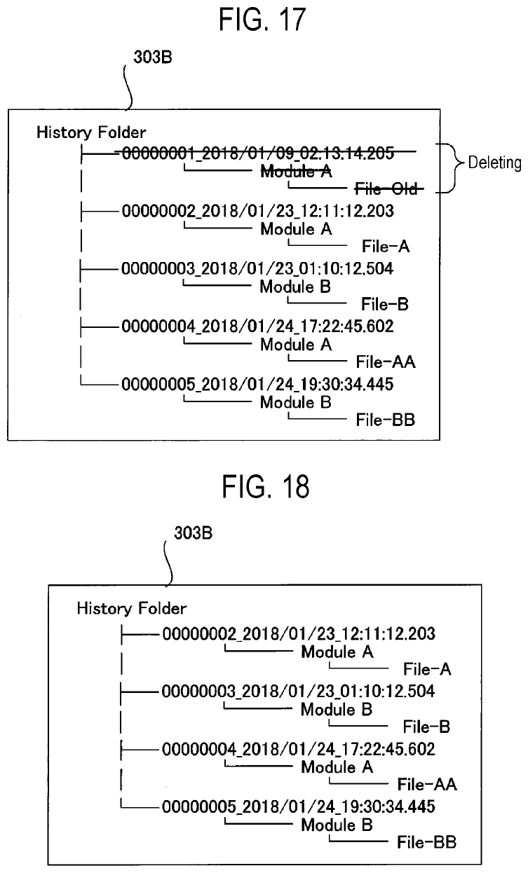

In the present embodiments, the system file for each module before a certain designated date and time is targeted for deletion, and the system file for each module on or after a certain designated date and time can be restored. Specifically, a case where the change history of the system file for each module on or after a certain designated date and time, i.e., Jan. 24, 2018, is set to be restorable will be described with reference to FIGS. 16 to 18.

First, the main controller 242 searches the history folder 303B and specifies the date folders before the designated date and time, 2018 Jan. 24, as deletion targets. Then, among the system files specified as deletion targets, one latest system file for each module is left, and the system files preceding the left system file for each module are deleted and erased. That is, among the system files before 2018 Jan. 24, the system file (File-A) of the latest date folder 2018 Jan. 23 for the module A and the system file (File-B) of the latest date folder 2018 Jan. 23 for the module B are left, and the system files (File-Old) in the date folder 2018 Jan. 9 for the module A preceding the system file (File-A) and the system file (File-B) are deleted and erased. The main controller 242 erases the subfolder whose system files are erased and the contents are empty. This makes it possible to restore the change history of the system file as of 0:00 on Jan. 24, 2018. That is, it is possible to restore the change history up to a certain designated date and time while satisfying the capacity limit of the memory 303.

As described above, according to each embodiment (the present embodiments) of the present disclosure, one or more of the following effects (a) to (h) may be obtained.
(a) According to the present embodiments, the system file is stored in the memory of the main controller when uploading or downloading the system file with respect to each module. Therefore, it is possible to automatically store the combinations of system files.
(b) Further, according to the present embodiments, the system file uploaded or downloaded for each module is stored in the memory of the main controller. Therefore, the system files can be stored in a chronological order, and the system files can be browsed in a chronological order.
(c) Further, according to the present embodiments, the system files are stored in the memory of the main controller in a chronological order. Therefore, it is possible to enable a user to see the combinations of system files (system file group) of the past specified date and time. In addition, the combinations of system files of the specified date and time in the past can be restored in each module.
(d) Further, according to the present embodiments, among the system files stored in the memory of the main controller, the system files preceding the designated date and time can be automatically deleted.
(e) According to the present embodiments, the system file for each module is uploaded or downloaded, and the uploaded or downloaded system file for the module is stored in the memory of the main controller. Therefore, even if the user upgrades the software without backing up the system files, it is possible to restore the system file for each module.
(f) Further, according to the present embodiments, even if the non-volatile memory of each module fails, it is possible to restore the system files because the system file for each module is stored in the memory of the main controller 242.
(g) Further, according to the present embodiments, even if an inappropriate backed-up system file is restored due to a user operation error, it is possible to restore the system file for each module because it is stored in the memory of the main controller 242.
(h) Further, according to the present embodiments, when it is desired to restore the system file at the time when a failure occurs in the past, the system file for each module at the time of failure can be restored by detecting the date folder at the time of failure because the system file for each module is stored in the uploaded or downloaded date folder.

The substrate processing apparatus 10 according to the embodiments of the present disclosure can be applied to the semiconductor manufacturing apparatus for manufacturing a semiconductor and to an apparatus for processing a glass substrate such as an LCD device or the like. It goes without saying that the substrate processing apparatus 10 can also be applied to various substrate processing apparatuses such as an exposure apparatus, a lithography apparatus, a coating apparatus, and a processing apparatus using plasma.

Although various typical embodiments of the present disclosure have been described above, the present disclosure is not limited to these embodiments. The embodiments may be used in combination as appropriate.

According to the present disclosure in some embodiments, it is possible to upgrade the software installed in a semiconductor manufacturing apparatus without affecting the data of system files.

While certain embodiments have been described, these embodiments have been presented by way of example and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A system, comprising:
at least one sub-controller configured to be capable of controlling at least one module; and
a main controller including a memory configured to be capable of including a first storage configured to be capable of storing a system file currently set in the module and a second storage configured to be capable of storing a history of uploading or downloading of the system file for the module as history information,
wherein the main controller is configured to, when transmitting and receiving the system file to and from the sub-controller, store the transmitted or received system file in the first storage and store the history information of the system file in the second storage, according to a comparison result between the transmitted or received system file and the system file stored in the first storage.

2. The system of claim 1, wherein the main controller is configured to store the history information, which shows a change history of the system file used in the module, in the second storage.

3. The system of claim 2, wherein the main controller is configured to store the system file uploaded or downloaded for the module in the second storage and in the first storage at the same time.

4. The system of claim 1, wherein when the system file for the module is uploaded and the uploaded system file is different from the system file stored in the first storage, or when the system file for the module is downloaded and the downloaded system file is different from the system file stored in the first storage, the main controller is configured to store the uploaded or downloaded system file in the first storage and store the history information of the system file in the second storage.

5. The system of claim 1, wherein when the module is connected to the main controller, the main controller is configured to make an upload request for the system file for the connected module.

6. The system of claim 1, wherein the main controller is configured to store the system file uploaded or downloaded for the module in a folder of the second storage whose folder name is set as a date of when the system file is uploaded or downloaded.

7. The system of claim 6, wherein the main controller is configured to add, to the folder name, a serial number incremented by 1 in an order stored in the second storage and a time of when the system file is uploaded or downloaded.

8. The system of claim 1, wherein the main controller is configured to, when a module is newly connected, upload a system file for the newly connected module and is configured to, when there is no difference between the system file stored in the first storage and the system file for the newly connected module, do nothing.

9. The system of claim 6, wherein the main controller is configured to search the second storage based on a designated date and leave one of the latest system file for the module before the designated date in the folder.

10. The system of claim 9, wherein the main controller is configured to erase the system file for the module preceding the latest system file for the module before the designated date.

11. The system of claim 6, wherein the main controller is configured to erase the folder whose contents are empty.

12. The system of claim 1, wherein the first storage is configured to store the same system file as the system file downloaded for the module.

13. The system of claim 1, wherein information on the system file uploaded or downloaded for the module is stored in the second storage in a chronological order.

14. The system of claim 3, wherein the second storage is configured to store a folder whose folder name is set as a date and time of when uploading or downloading is performed for the module, and the folder is configured to store the uploaded or downloaded system file and information about the module for which uploading or downloading is performed.

15. A substrate processing apparatus, comprising:
at least one sub-controller configured to be capable of controlling at least one module; and
a main controller including a memory configured to be capable of including a first storage configured to be capable of storing a system file currently set in the module and a second storage configured to be capable of storing a history of uploading or downloading of the system file for the module as history information,
wherein the main controller is configured to, when transmitting and receiving the system file to and from the sub-controller, store the transmitted or received system file in the first storage and store the history information of the system file in the second storage, according to a comparison result between the transmitted or received system file and the system file stored in the first storage.

16. A method of manufacturing a semiconductor device, comprising:
when transmitting and receiving a system file between at least one sub-controller configured to be capable of controlling at least one module, and a main controller including a memory configured to be capable of including a first storage configured to be capable of storing a system file currently set in the module and a second storage configured to be capable of storing a history of uploading or downloading of the system file for the module as history information, a history-information-storing process of storing the transmitted or received system file in the first storage and storing the history information of the system file in the second storage, according to a comparison result between the transmitted or received system file and the system file stored in the first storage; and
a substrate-processing process of processing a substrate by executing a process recipe by using the system file.

17. A non-transitory computer-readable recording medium storing a program that causes, by a main controller, a substrate processing apparatus to perform the history-information-storing process and the substrate-processing process of claim 16.
